(19) United States
(12) Patent Application Publication
(10) Pub. No.: US 2022/0171926 A1
(43) Pub. Date: Jun. 2, 2022

(54) INFORMATION PROCESSING METHOD, STORAGE MEDIUM, AND INFORMATION PROCESSING DEVICE

(71) Applicant: FUJITSU LIMITED, Kawasaki-shi (JP)

(72) Inventors: Tomoya Iwakura, Kawasaki (JP); Takuya Makino, Kawasaki (JP)

(73) Assignee: FUJITSU LIMITED, Kawasaki-shi (JP)

(21) Appl. No.: 17/671,461

(22) Filed: Feb. 14, 2022

Related U.S. Application Data
(63) Continuation of application No. PCT/JP2019/034100, filed on Aug. 30, 2019.

(51) Int. Cl. G06F 40/242; G06F 40/166; G06F 40/279

(52) U.S. Cl. CPC G06F 40/242; G06F 40/279; G06F 40/166

(57) ABSTRACT

An information processing method for a computer to execute a process includes extracting, from a first document, a word not included in a second document; registering the word in a first dictionary; acquiring an intermediate representation vector by inputting a word included in the second document to a recursion-type encoder; acquiring a first probability distribution based on a result of inputting the intermediate representation vector to a recursion-type decoder that calculates a probability distribution of each word registered in the first dictionary; acquiring a second probability distribution of a second dictionary of a word included in the second document based on a hidden state vector calculated by inputting each word included in the second document to the recursion-type encoder and a hidden state vector output from the recursion-type decoder; and generating word included in the first document based on the first probability distribution and the second probability distribution.

### CROSS-REFERENCE TO RELATED APPLICATION

This application is a continuation application of International Application PCT/JP2019/034100 filed on Aug. 30, 2019 and designated the U.S., the entire contents of which are incorporated herein by reference.

### FIELD

The embodiment discussed herein is related to an information processing method, a storage medium, and an information processing method.

### BACKGROUND

There is a case where machine learning such as a neural network (NN) is used for automatic summarization for generating a summary sentence from a document such as newspapers, websites, or electric bulletin boards. For example, a model in which a recurrent neural networks (RNN) encoder that vectorizes an input sentence and an RNN decoder that refers to the vector of the input sentence and repeatedly generates a word in the summary sentence are connected is used to generate the summary sentence.

In addition, a Pointer-Generator has been proposed (Pointer Generator Networks) that can copy a word in an input sentence as a word in a summary sentence when the RNN decoder outputs the word in the summary sentence, by combining a Pointer function with the RNN.

FIGS. 16 to 21 are diagrams for explaining a traditional Pointer-Generator. In FIGS. 16 to 21, a case will be described where a summary sentence 10b is generated from an input sentence 10a using a learned encoder 20 and a decoder 30. A device that executes a traditional Pointer-Generator is referred to as a “traditional device”. The input sentence 10a is set as “announcement of direction of natural language processing”.

FIG. 16 will be described. The traditional device calculates an intermediate representation by inputting the input sentence 10a to the encoder 20. The traditional device inputs the intermediate representation (vector) and a head symbol BOS of a word to a long short-term memory (LSTM) 31-T1 of the decoder 30 so as to calculate a probability distribution D2 of each word included in a summary word dictionary. The summary word dictionary is a dictionary that defines a word included in a summary sentence and is developed on a memory to be used.

The traditional device calculates a probability distribution D1 of each word copied from the input sentence 10a on the basis of a hidden state vector h calculated when the input sentence 10a is input to the encoder 20 and a hidden state vector H1 output from the LSTM 31-T1.

FIG. 17 will be described. The traditional device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of the word “NLP” is maximized in the probability distribution D3, the traditional device sets the “NLP” as a first character of the summary sentence 10b. Note that the weight such as “0.2” or “0.8” is determined by learning. Furthermore, although the weight can be dynamically changed according to a state, the weight is set to a fixed value for simplification of explanation.

FIG. 18 will be described. The traditional device calculates the probability distribution D2 of each word included in the summary word dictionary by inputting a vector of “NLP” and the hidden state vector H1 output from the LSTM 31-T1 to a LSTM 31-T2.

The traditional device calculates the probability distribution D1 of each word copied from the input sentence 10a on the basis of the hidden state vector h and a hidden state vector H2 output from the LSTM 31-T2.

FIG. 19 will be described. The traditional device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of a word “of” is maximized in the probability distribution D3, the traditional device sets “of” as a second character of the summary sentence 10b.

FIG. 20 will be described. The traditional device calculates the probability distribution D2 of each word included in the summary word dictionary by inputting a vector of “of” and the hidden state vector H2 output from the LSTM 31-T2 to a LSTM 31-T3.

The traditional device calculates the probability distribution D1 of each word copied from the input sentence 10a on the basis of the hidden state vector h and a hidden state vector H3 output from the LSTM 31-T3.

FIG. 21 will be described. The traditional device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of a word “direction” is maximized in the probability distribution D3, the traditional device sets the “direction” as a third character of the summary sentence 10b.

As described above, by executing the processing in FIGS. 16 to 21, the traditional device generates the summary sentence 10b “direction of NLP” from the input sentence 10a “announcement of direction of natural language processing”.

Here, an example of summary word dictionary generation processing used by the traditional device will be described. FIG. 22 is a diagram for explaining traditional summary dictionary generation processing. When acquiring learning data 40 in which an input sentence and a summary sentence are paired, the traditional device generates a summary word dictionary on the basis of each summary sentence included in the learning data 40. For example, the traditional device specifies a frequency of each word included in the summary sentence and registers a word of which the frequency is equal to or more than a threshold to the summary word dictionary. A relationship between the word included in each summary sentence and the frequency is as indicated in a table 41.

Japanese Laid-open Patent Publication No. 2019-117486 is disclosed as related art.

### SUMMARY

According to an aspect of the embodiments, an information processing method for a computer to execute a process includes extracting, from a first document, a word that is not included in a second document; registering the word in a first dictionary; acquiring an intermediate representation vector by inputting a word included in the second document to a recursion-type encoder in order; acquiring a first probability distribution based on a result of inputting the intermediate representation vector to a recursion-type decoder that calculates a probability distribution of each word registered in the first dictionary; acquiring a second probability distribution of a second dictionary of a word included in the second document based on a hidden state vector calculated by inputting each word included in the second document to the recursion-type encoder and a hidden state vector output from the recursion-type decoder; and generating word included in the first document based on the first probability distribution and the second probability distribution.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining processing for generating a summary word dictionary by an information processing device according to the present embodiment;

FIG. 2 is a diagram for explaining a reason for comparing a pair of an input sentence and a summary sentence;

FIG. 3 is a diagram (1) for explaining processing for generating a summary sentence by the information processing device according to the present embodiment;

FIG. 4 is a diagram (2) for explaining the processing for generating the summary sentence by the information processing device according to the present embodiment;

FIG. 5 is a diagram (3) for explaining the processing for generating the summary sentence by the information processing device according to the present embodiment;

FIG. 6 is a diagram (4) for explaining the processing for generating the summary sentence by the information processing device according to the present embodiment;

FIG. 7 is a diagram (5) for explaining the processing for generating the summary sentence by the information processing device according to the present embodiment;

FIG. 8 is a diagram (6) for explaining the processing for generating the summary sentence by the information processing device according to the present embodiment;

FIG. 9 is a diagram for explaining learning processing of the information processing device according to the present embodiment;

FIG. 10 is a functional block diagram illustrating a configuration of the information processing device according to the present embodiment;

FIG. 11 is a diagram illustrating an example of a data structure of the summary word dictionary;

FIG. 12 is a diagram illustrating an example of a data structure of an original text dictionary;

FIG. 13 is a flowchart illustrating a processing procedure of the information processing device according to the present embodiment;

FIG. 14 is a flowchart illustrating a processing procedure of summary word dictionary generation processing;

FIG. 15 is a diagram illustrating an example of a hardware configuration of a computer that implements functions similar to the information processing device;

FIG. 16 is a diagram (1) for explaining a traditional Pointer-Generator;

FIG. 17 is a diagram (2) for explaining the traditional Pointer-Generator;

FIG. 18 is a diagram (3) for explaining the traditional Pointer-Generator;

FIG. 19 is a diagram (4) for explaining the traditional Pointer-Generator;

FIG. 20 is a diagram (5) for explaining the traditional Pointer-Generator;

FIG. 21 is a diagram (6) for explaining the traditional Pointer-Generator; and

FIG. 22 is a diagram for explaining processing for generating a traditional summary word dictionary.

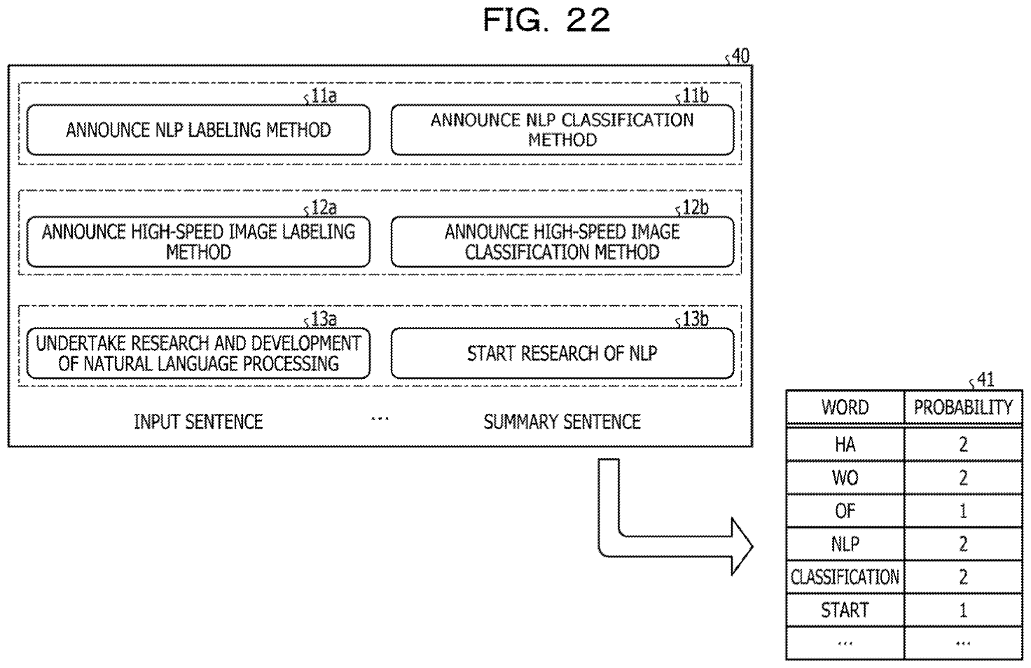

### DESCRIPTION OF EMBODIMENTS

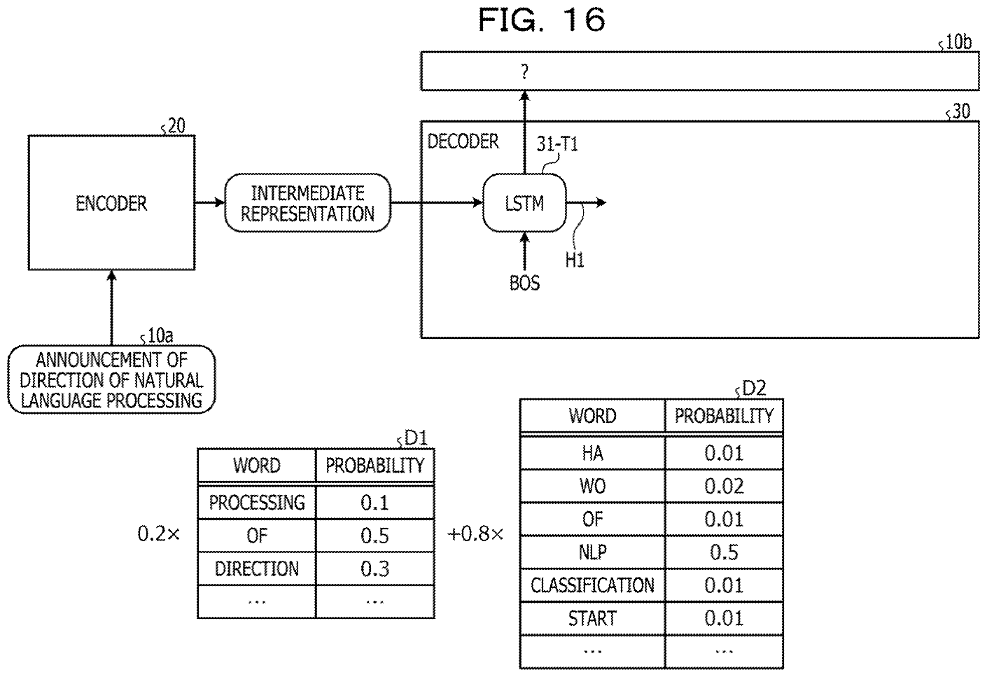

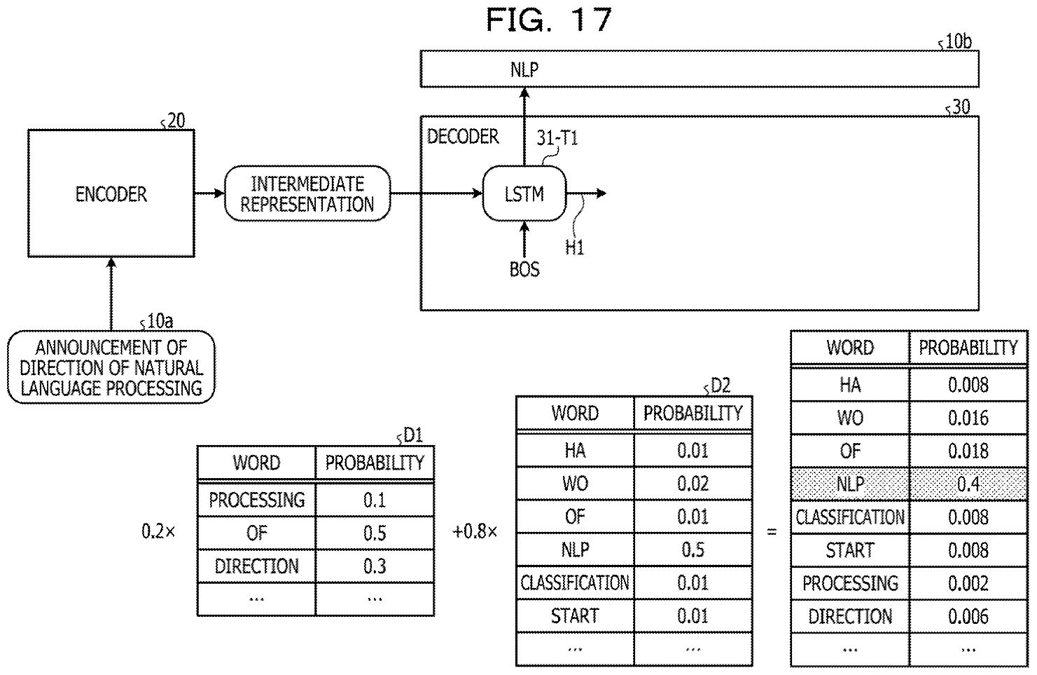

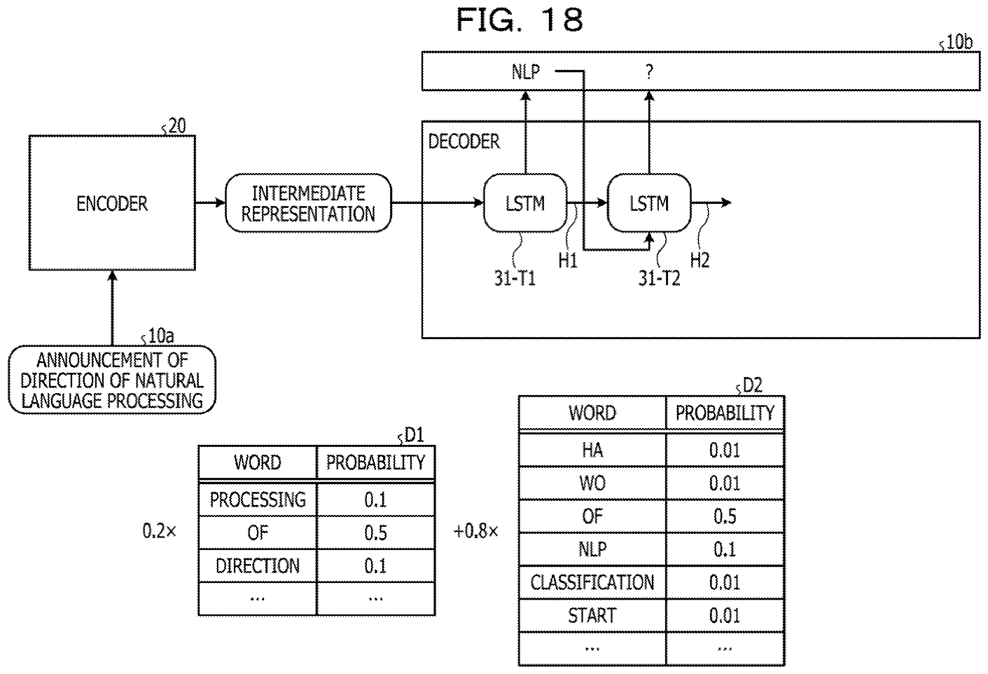

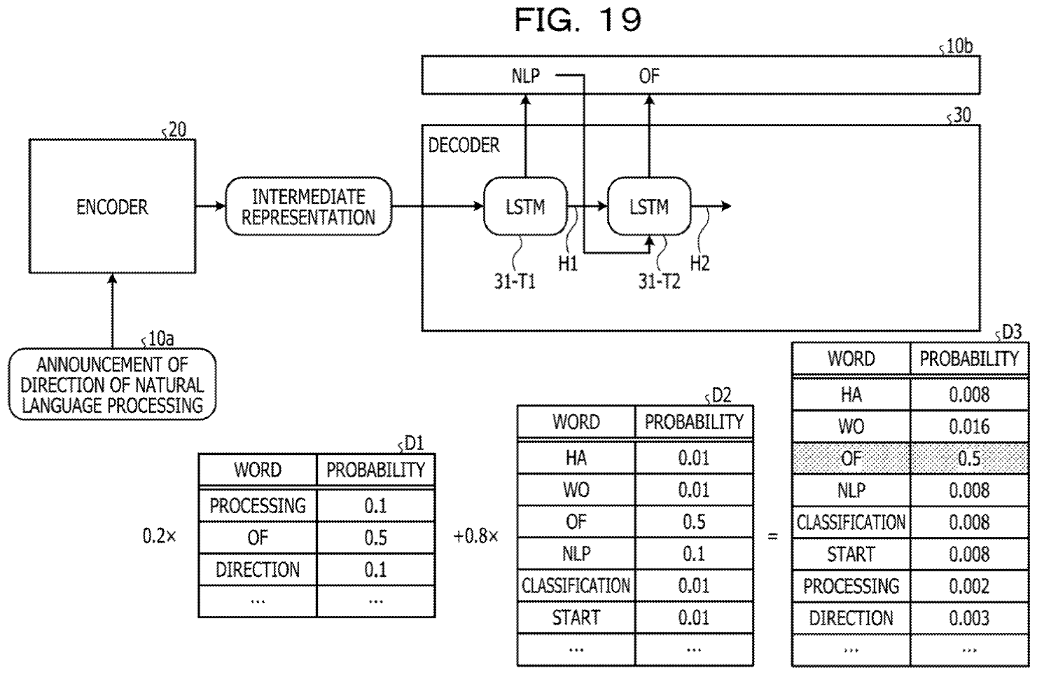

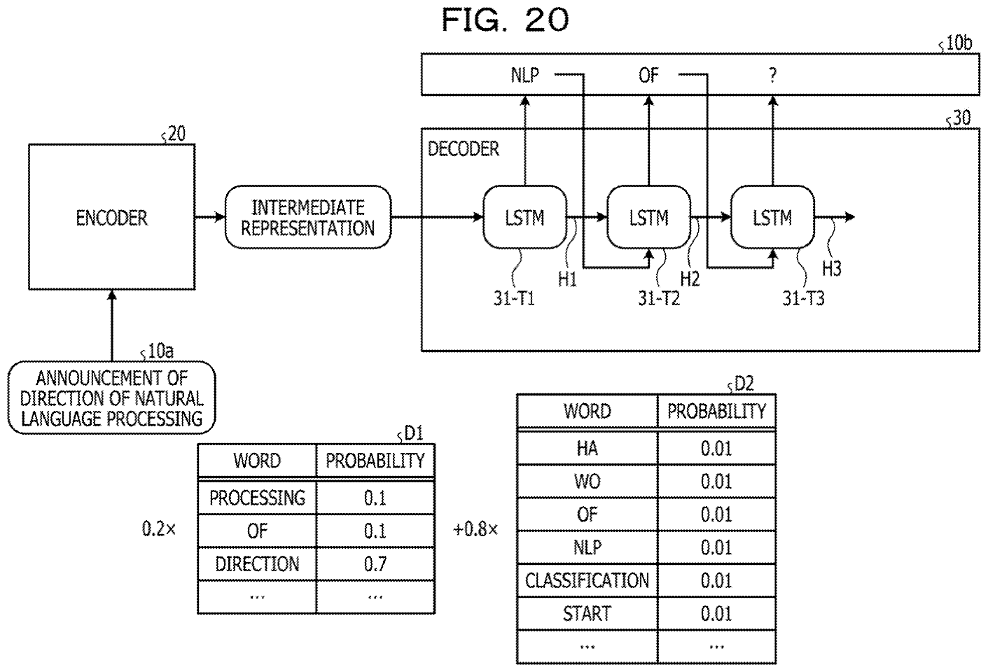

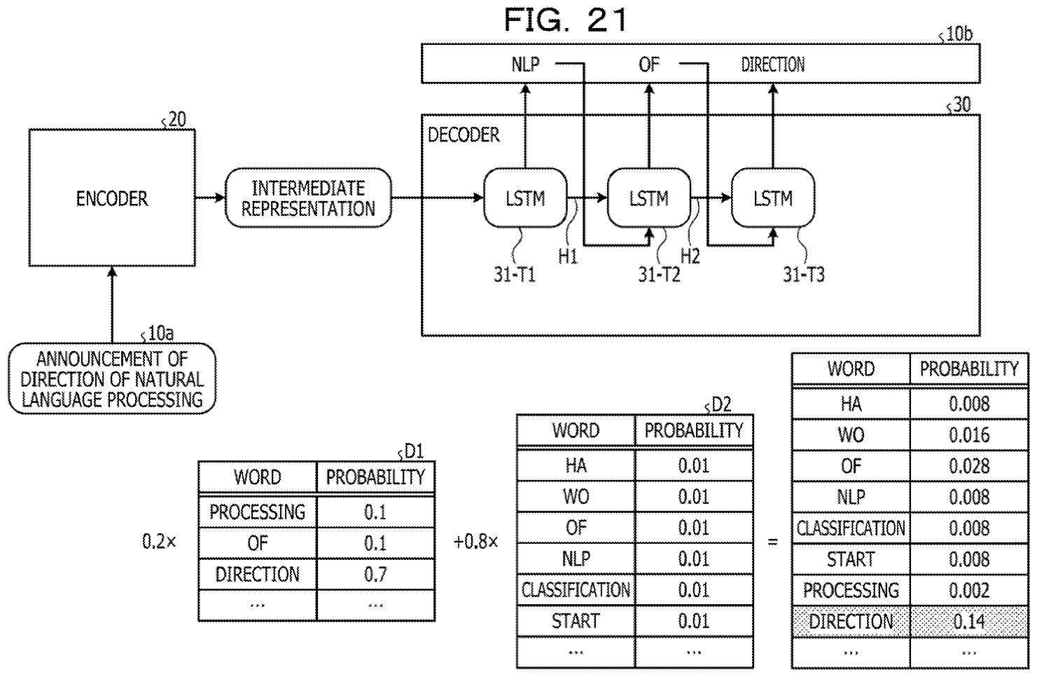

As described with reference to FIGS. 16 to 21, the traditional device develops the summary word dictionary on the memory and specifies the words in the summary sentence 10b on the basis of the probability distribution D1 of each word copied from the input sentence 10a and the probability distribution D2 of each word included in the summary word dictionary.

Here, the word copied from the input sentence 10a includes a word same as the word registered in the summary word dictionary, and a word that can be a copy of the input sentence 10a is included in the summary word dictionary. Therefore, there is room for reducing words registered in the summary word dictionary and reducing a memory usage. For example, in FIGS. 16 to 21, “of” included in the summary word dictionary is included in the copy of the word in the input sentence 10a.

In one aspect, an object of the embodiment is to provide an information processing method, an information processing program, and an information processing device that can reduce a memory usage.

Hereinafter, embodiments of an information processing method, an information processing program, and an information processing device according to the present disclosure will be described in detail with reference to the drawings. Note that the embodiment does not limit the present disclosure.

### Embodiment

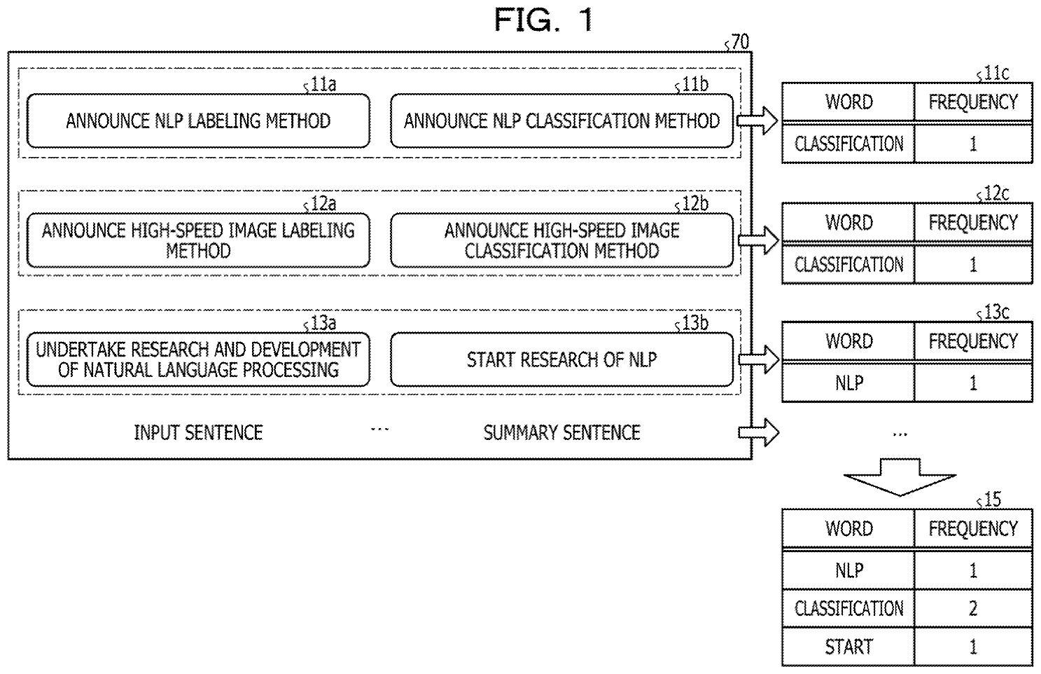

An example of processing for generating a summary word dictionary used by a Pointer-Generator by an information processing device according to the present embodiment will be described. FIG. 1 is a diagram for explaining processing for generating the summary word dictionary by the information processing device according to the present embodiment. The information processing device according to the present embodiment compares each pair of an input sentence and a summary sentence and registers a word that is included only in the summary sentence in the summary word dictionary. The input sentence corresponds to a “second document”. The summary sentence corresponds to a “first document”.

In FIG. 1, learning data 70 includes a pair of an input sentence 11a and a summary sentence 11b, a pair of an input sentence 12a and a summary sentence 12b, and a pair of an input sentence 13a and a summary sentence 13b. The learning data 70 may include a pair of another input sentence and another summary sentence.

The information processing device compares each word in the input sentence 11a with each word in the summary sentence 11b and extracts a word “classification” included only in the summary sentence 11b. An extraction result 11c includes the extracted word “classification” and a frequency “1”.

The information processing device compares each word in the input sentence 12a with each word in the summary sentence 12b and extracts a word “classification” included only in the summary sentence 12b. An extraction result 12c includes the extracted word “classification” and a frequency “1”.

The information processing device compares each word in the input sentence 13a with each word in the summary sentence 13b and extracts a word “NLP” included only in the summary sentence 13b. An extraction result 13c includes the extracted word “NLP” and a frequency “1”.

From a pair of another input sentence and another summary sentence, the information processing device extracts a word included only in the summary sentence. The information processing device repeatedly executes processing for associating the extracted word with the frequency. The information processing device aggregates the extraction results 11c to 13c (other extraction results) so as to generate an aggregation result 15 in which the word and the frequency are associated. The information processing device registers the word included in the aggregation result in the summary word dictionary. The information processing device may register a word of which a frequency is equal to or more than a threshold among the words included in the aggregation result in the summary word dictionary. The summary word dictionary corresponds to a “first dictionary”.

The information processing device according to the present embodiment executes the processing described with reference to FIG. 1. By generating the summary word dictionary, the information processing device registers a word that exists only in a summary sentence in a pair of an input sentence and the summary sentence in the summary word dictionary. Therefore, it is possible to reduce a data amount of the summary word dictionary, and it is possible to reduce a memory usage.

Note that the information processing device does not compare a set of words in all input sentences with a set of words in all summary sentences. If the set of the words in all the input sentences is compared with the set of the words in all the summary sentences and a word that exists only in the summary sentence side is registered in the summary word dictionary, there is a case where it is not possible to appropriately generate a summary sentence using the summary word dictionary.

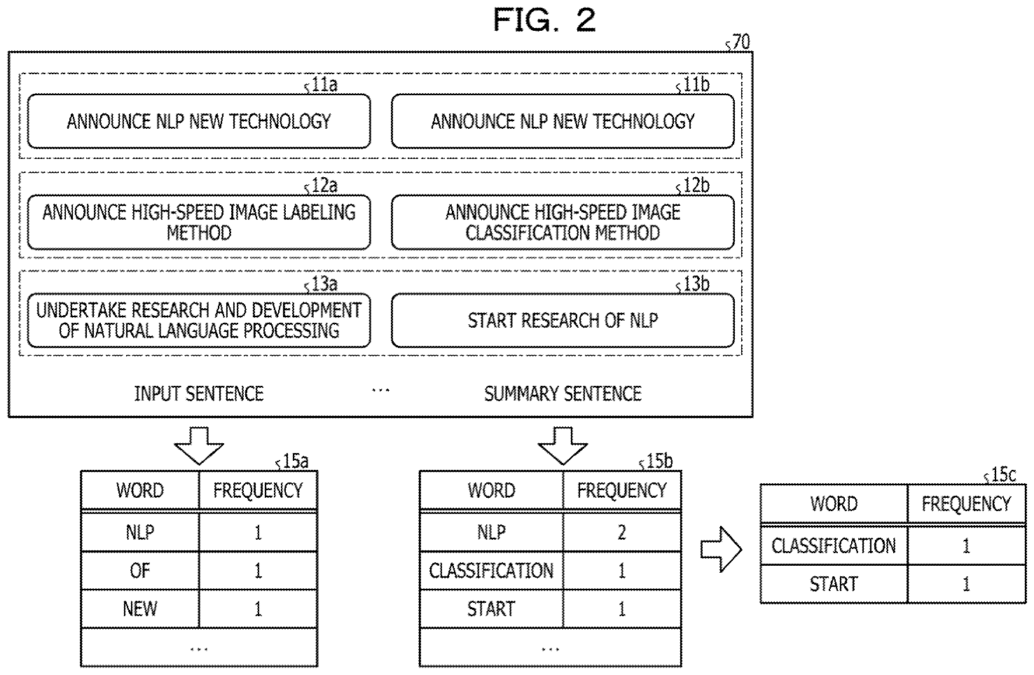

FIG. 2 is a diagram for explaining a reason for comparing a pair of an input sentence and a summary sentence. In FIG. 2, when a word and a frequency are extracted from each of the input sentences 11a to 13a (another input sentence included in learning data 70), an extraction result 15a is obtained. When a word and a frequency are extracted from each of the summary sentences 11b to 13b (another summary sentence included in learning data 70) included in the learning data 70, an extraction result 15b is obtained. A word that exists in the extraction result 15a and does not exist in the extraction result 15b is indicated by an extraction result 15c.

For example, a case will be assumed where words “classification” and “start” included in the extraction result 15c are registered in the summary word dictionary and a summary sentence of the input sentence 13a is generated using the summary word dictionary. In this case, because “NLP” corresponding to “natural language processing” is not registered in the summary word dictionary, a corresponding word is not found, and it is not possible to generate an appropriate summary sentence. On the other hand, because “NLP” is registered in the summary word dictionary in the processing described with reference to FIG. 1, an appropriate summary sentence can be generated.

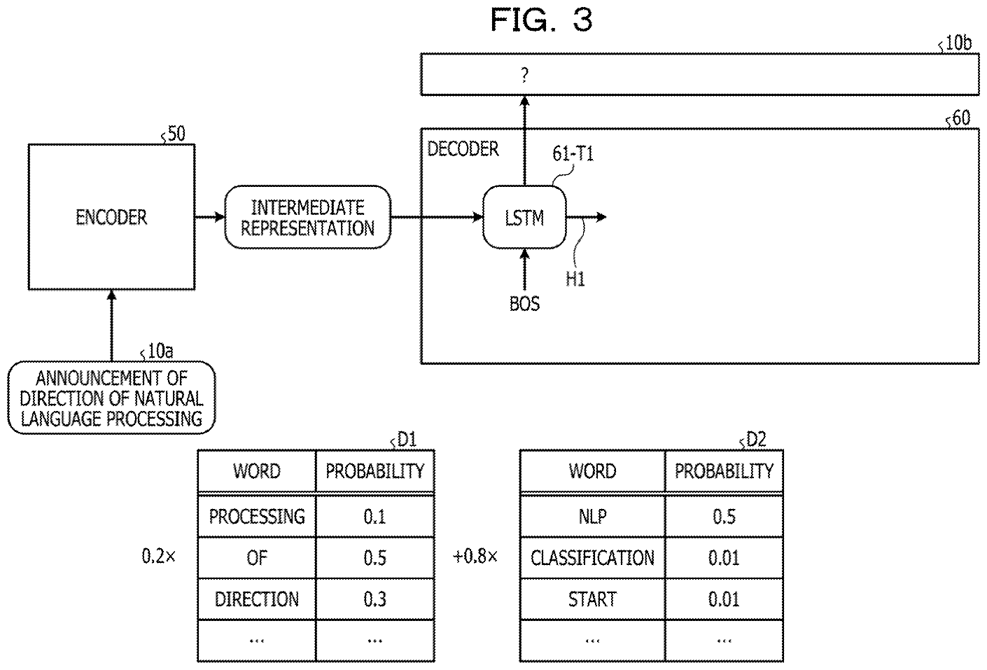

Subsequently, an example of processing for generating a summary sentence from an input sentence using the summary word dictionary generated by the processing described with reference to FIG. 1 by the information processing device according to the present embodiment will be described. FIGS. 3 to 8 are diagrams for explaining the processing for generating a summary sentence by the information processing device according to the present embodiment.

FIG. 3 will be described. The information processing device calculates an intermediate representation by inputting an input sentence 10a in an encoder 50. The information processing device inputs an intermediate representation (vector) and a head symbol of a word <begin of sentence (BOS)> to a long short-term memory (LSTM) 61-T1 of a decoder 60 so as to calculate a probability distribution D2 of each word included in the summary word dictionary. The probability distribution D2 corresponds to a “first probability distribution”.

The summary word dictionary used in the present embodiment is the summary word dictionary generated by the processing described with reference to FIG. 1, and a word included only in a summary sentence as a result of comparing a pair of an input sentence and the summary sentence is registered in the summary word dictionary. Therefore, a size of the summary word dictionary used in the present embodiment is smaller than a summary word dictionary used by a traditional device described with reference to FIGS. 16 to 21.

The information processing device calculates a probability distribution D1 of each word copied from the input sentence 10a on the basis of a hidden state vector h calculated when the input sentence 10a is input to the encoder 50 and a hidden state vector H1 output from the LSTM 61-T1. The probability distribution D1 corresponds to a “second probability distribution”.

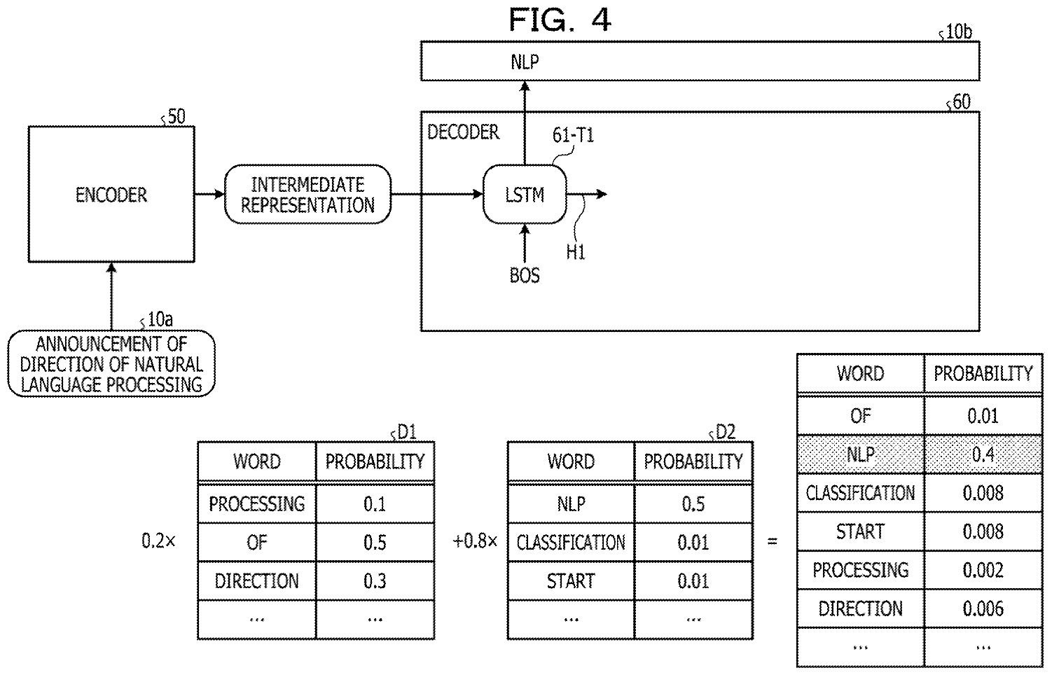

FIG. 4 will be described. The information processing device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of the word “NLP” is maximized in the probability distribution D3, the information processing device sets the “NLP” as a first character of the summary sentence 10b.

A weight with respect to the probability distribution D1 and a weight with respect to the probability distribution D2 are preset. In a case where a priority of the summary word dictionary is increased, the information processing device makes the weight of the probability distribution D2 be larger than the weight of the probability distribution D1.

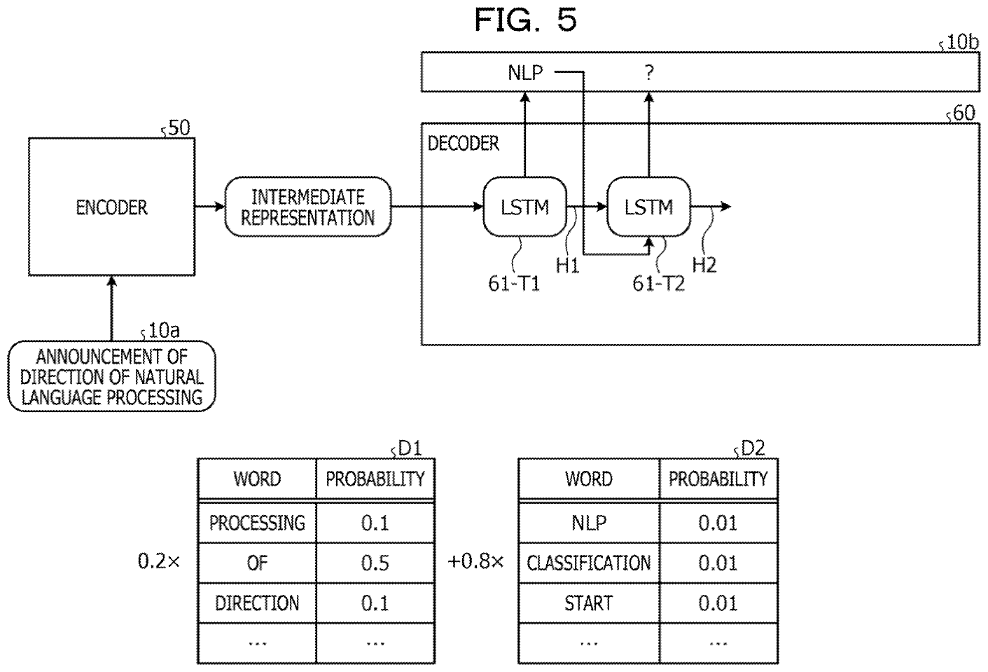

FIG. 5 will be described. The information processing device calculates the probability distribution D2 of each word included in the summary word dictionary by inputting a vector of “NLP” and the hidden state vector H1 output from the LSTM 61-T1 to a LSTM 61-T2.

The information processing device calculates the probability distribution D1 of each word copied from the input sentence 10a on the basis of the hidden state vector h and a hidden state vector H2 output from the LSTM 61-T2.

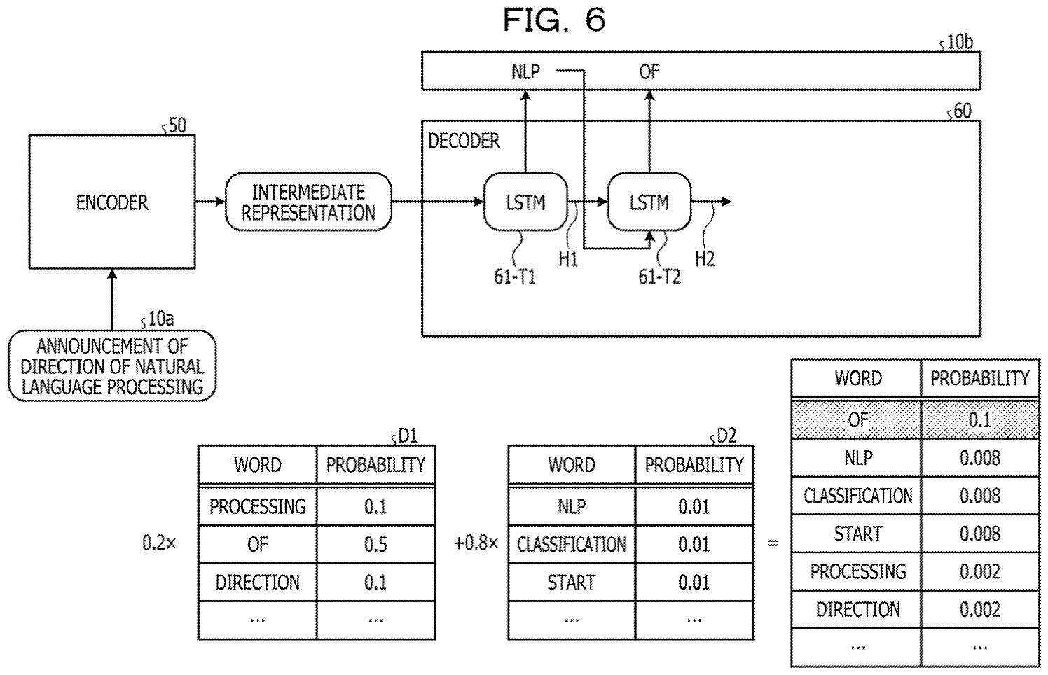

FIG. 6 will be described. The information processing device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of a word “of” is maximized in the probability distribution D3, the information processing device sets “of” as a second character of the summary sentence 10b.

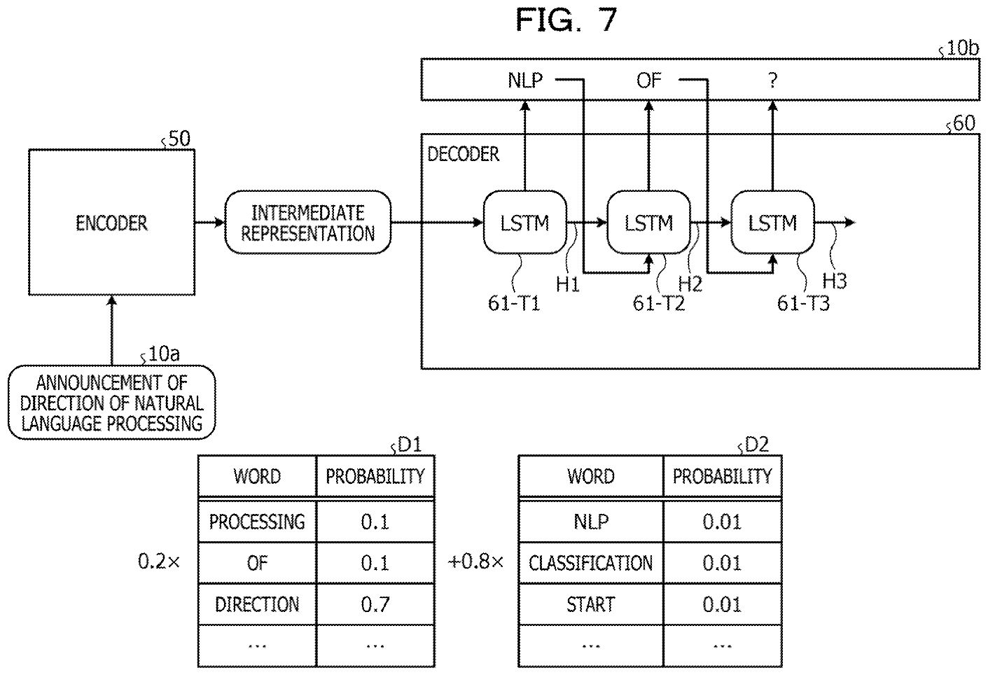

FIG. 7 will be described. The information processing device calculates the probability distribution D2 of each word included in the summary word dictionary by inputting a vector of “of” and the hidden state vector H2 output from the LSTM 61-T2 to a LSTM 61-T3.

The information processing device calculates the probability distribution D1 of each word copied from the input sentence 10a on the basis of the hidden state vector h and a hidden state vector H3 output from the LSTM 61-T3.

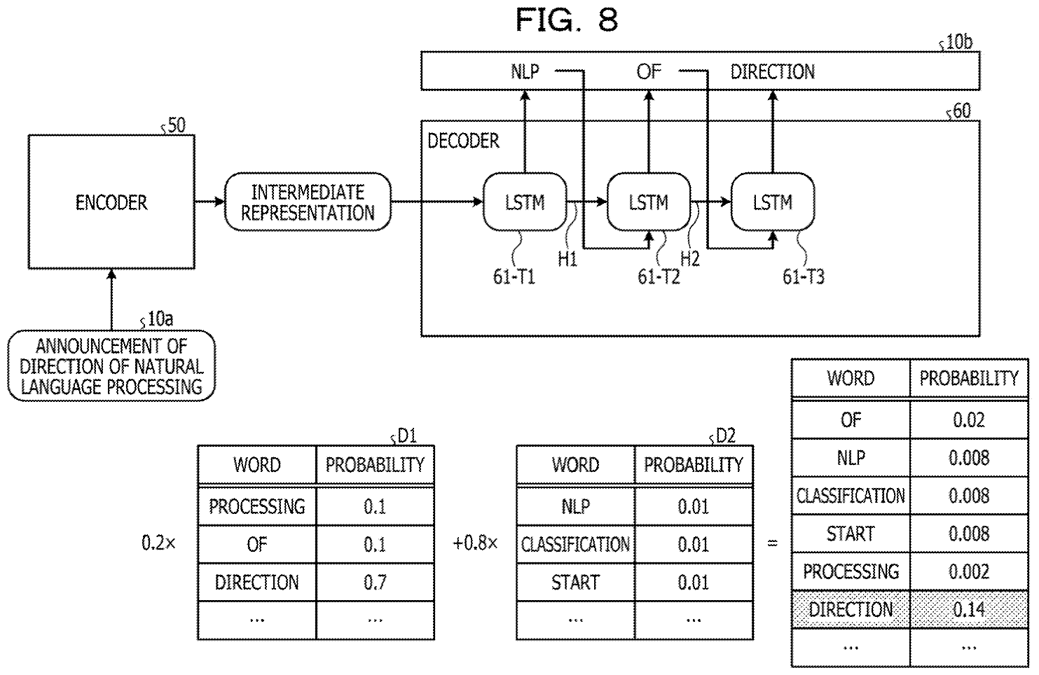

FIG. 8 will be described. The information processing device calculates a probability distribution D3 obtained by adding a probability distribution obtained by multiplying the probability distribution D1 by a weight “0.2” and a probability distribution obtained by multiplying the probability distribution D2 by a weight “0.8”. Then, because a probability of a word “direction” is maximized in the probability distribution D3, the information processing device sets the “direction” as a third character of the summary sentence 10b.

As described above, according to the information processing device according to the present embodiment, by executing the processing in FIGS. 1 to 8, it is possible to generate the summary sentence 10b “direction of NLP” from the input sentence 10a “announcement of direction of natural language processing”.

The summary word dictionary used in the present embodiment is the summary word dictionary generated by the processing described with reference to FIG. 1, and a word included only in a summary sentence as a result of comparing a pair of an input sentence and the summary sentence is registered in the summary word dictionary. Therefore, a size of the summary word dictionary used in the present embodiment is smaller than the summary word dictionary used by the traditional device described with reference to FIGS. 16 to 21, and therefore, a memory usage can be reduced. Furthermore, because the size of the summary word dictionary is reduced, a processing speed can be increased as compared with the traditional device.

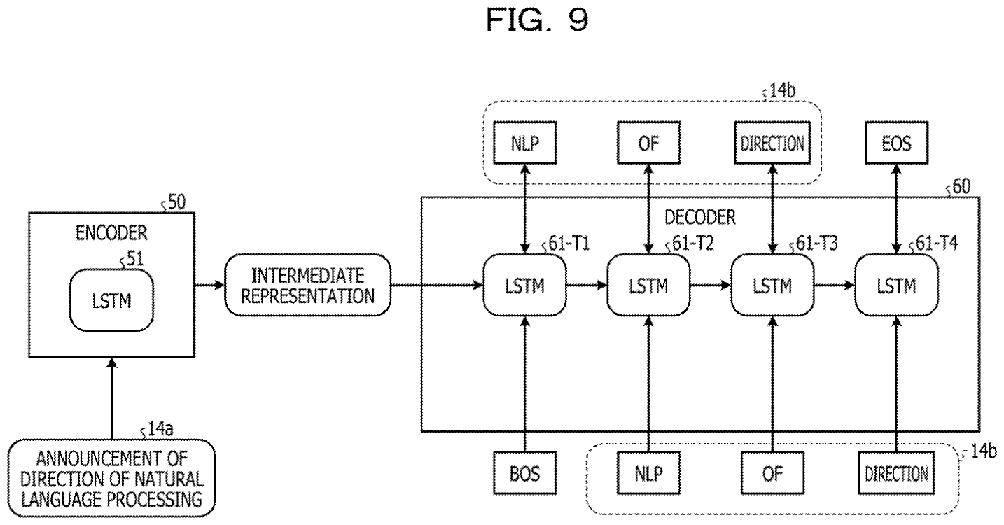

Next, an example of processing for learning the encoder 50 and the decoder 60 illustrated in FIGS. 3 to 8 by the information processing device according to the present embodiment will be described. FIG. 9 is a diagram for explaining learning processing of the information processing device according to the present embodiment. As an example in FIG. 9, an input sentence 14a for learning is set as “announcement of direction of natural language processing”, and a summary sentence 14b to be paired with the input sentence 14a is set as “direction of NLP”.

The encoder 50 includes a LSTM 51. The LSTM 51 receives an input of a vector of each word in the input sentence 14a in order. The LSTM 51 performs calculation based on the vector of each word in the input sentence 14a and a parameter θ₅₁ of the LSTM 51 and outputs a hidden state vector to a next LSTM 51. The next LSTM 51 calculates a next hidden state vector on the basis of the hidden state vector calculated by the previous LSTM 51 and a vector of the next word. The LSTM 51 repeatedly executes the above processing on each word in the input sentence 14a. The LSTM 51 outputs a hidden state vector calculated when a final word in the input sentence 14a is input to the decoder 60 as an intermediate representation.

The decoder 60 includes the LSTMs 61-T1, 61-T2, 61-T3, and 61-T4. The LSTMs 61-T1, 61-T2, 61-T3, and 61-T4 are collectively referred to as a LSTM 61.

The LSTM 61 receives the intermediate representation (vector) from the encoder 50 and receives an input of a vector of a word in the summary sentence 14b. The LSTM 61 calculates a hidden state vector by performing calculation based on the intermediate representation, the vector of the word, and a parameter θ₆₁ of the LSTM 61. The LSTM 61 transfers the hidden state vector to a LSTM 61 of a next word. The LSTM 61 repeatedly executes the above processing each time when the vector of the word is input.

The information processing device calculates the probability distribution D2 (not illustrated) of each word included in the summary word dictionary on the basis of the hidden state vector output from the LSTM 61 and the summary word dictionary. Furthermore, the information processing device calculates the probability distribution D1 (not illustrated) of each word copied from the input sentence 14a on the basis of the hidden state vector calculated when the input sentence 14a is input to the encoder 50 and the hidden state vector output from the LSTM 61. The information processing device calculates the probability distribution D3 (not illustrated) obtained by adding the probability distributions D1 and D2. Each time when the vector of each word in the summary sentence 14b is input to the LSTM 61, the information processing device calculates the probability distribution D3.

Here, in a case where each word in the summary sentence 14b is input to the LSTM 61, the information processing device inputs “begin of sentence (BOS)” as a word indicating a head of a sentence at the beginning. Furthermore, the information processing device sets “end of sentence (EOS)” as a word indicating the end of the summary sentence 14b to be compared in a case where a loss from the probability distribution D3 is calculated.

The information processing device updates the intermediate representation of the LSTM 61 with the intermediate representation output from the encoder 50, and then, executes processing from a subsequent first time to a fourth time in order.

The information processing device calculates a hidden state vector by inputting an output (intermediate representation) of the LSTM 51 of the encoder 50 and a vector of the word “BOS” to the LSTM 61-T1 at the first time. The information processing device calculates the probability distribution D3 of each word. The information processing device compares the calculated probability distribution with a correct word “NLP” and calculates a loss at the first time.

The information processing device calculates a hidden state vector by inputting an output of the previous LSTM 61-T1 and the vector of the word “NLP” to the LSTM 61-T2 at the second time. The information processing device calculates the probability distribution D3 of each word. The information processing device compares the calculated probability distribution with a correct word “of” and calculates a loss at the second time.

The information processing device calculates a hidden state vector by inputting an output of the previous LSTM 61-T2 and the vector of the word “of” to the LSTM 61-T3 at the third time. The information processing device calculates the probability distribution D3 of each word. The information processing device compares the calculated probability distribution with a correct word “direction” and calculates a loss at the third time.

The information processing device calculates a hidden state vector by inputting an output of the previous LSTM 61-T3 and the vector of the word “direction” to the LSTM 61-T4 at the fourth time. The information processing device calculates the probability distribution D3 of each word. The information processing device compares the calculated probability distribution with a correct word “EOS” and calculates a loss at the fourth time.

The information processing device updates the parameter θ₅₁ of the LSTM 51 and the parameter θ₆₁ of the LSTM 61 so as to minimize the losses calculated at the first to fourth times. For example, the information processing device updates the parameter θ₅₁ of the LSTM 51 and the parameter θ₆₁ of the LSTM 61 by optimizing a log likelihood on the basis of the losses at the first to fourth times.

The information processing device repeatedly executes the above processing using the pair of the input sentence and the summary sentence included in the learning data so as to learn the parameters including the parameter θ₅₁ of the LSTM 51 and the parameter θ₆₁ of the LSTM 61.

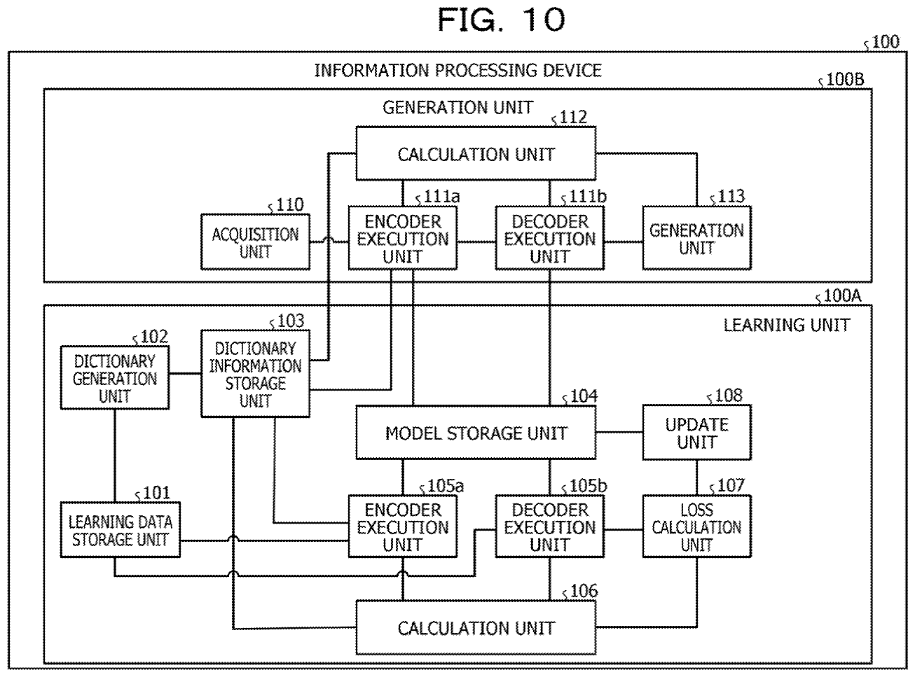

Next, an example of a configuration of the information processing device according to the present embodiment will be described. FIG. 10 is a functional block diagram illustrating the configuration of the information processing device according to the present embodiment. As illustrated in FIG. 10, an information processing device 100 includes a learning unit 100A and a generation unit 100B. A loss calculation unit 107 and an update unit 108 included in the learning unit 100A and a generation unit 113 included in the generation unit 100B are examples of an “information processing unit”.

For example, the learning unit 100A and the generation unit 100B can be implemented by a central processing unit (CPU), a micro processing unit (MPU), or the like. Furthermore, the learning unit 100A and the generation unit 100B can be implemented by a hard-wired logic such as an application specific integrated circuit (ASIC) or a field programmable gate array (FPGA).

A learning data storage unit 101, a dictionary information storage unit 103, a model storage unit 104 correspond to a semiconductor memory element such as a random access memory (RAM) or a flash memory (flash memory) or a storage device such as a hard disk drive (HDD).

The learning unit 100A generates the summary word dictionary described with reference to FIG. 1. Furthermore, the learning unit 100A executes the learning processing described with reference to FIG. 9. The learning unit 100A includes the learning data storage unit 101, a dictionary generation unit 102, the dictionary information storage unit 103, the model storage unit 104, an encoder execution unit 105a, a decoder execution unit 105b, a calculation unit 106, the loss calculation unit 107, and the update unit.

The learning data storage unit 101 is a storage device that stores the learning data 70 described with reference to FIG. 1. As described with reference to FIG. 1, the learning data 70 includes the pair of the input sentence 11a and the summary sentence 11b, the pair of the input sentence 12a and the summary sentence 12b, and the pair of the input sentence 13a and the summary sentence 13b. The learning data 70 may include a pair of another input sentence and another summary sentence.

The dictionary generation unit 102 is a processing unit that generates the summary word dictionary by comparing each pair of the input sentence and the summary sentence of the learning data 70 stored in the learning data storage unit 101 and registering the word that is included only in the summary sentence in the summary word dictionary. Processing for generating the summary word dictionary by the dictionary generation unit 102 corresponds to the processing described with reference to FIG. 1. The dictionary generation unit 102 stores information of the summary word dictionary in the dictionary information storage unit 103. The dictionary generation unit 102 may exclude a word of which a frequency is less than a threshold from the summary word dictionary.

Furthermore, the dictionary generation unit 102 generates an original text dictionary on the basis of each input sentence included in the learning data 70. The original text dictionary is an example of a “second dictionary”. The dictionary generation unit 102 stores information of the generated original text dictionary in the dictionary information storage unit 103. For example, the dictionary generation unit 102 generates the original text dictionary by counting words in each input sentence included in the learning data 70. The dictionary generation unit 102 may exclude a word of which a frequency is less than the threshold from the original text dictionary.

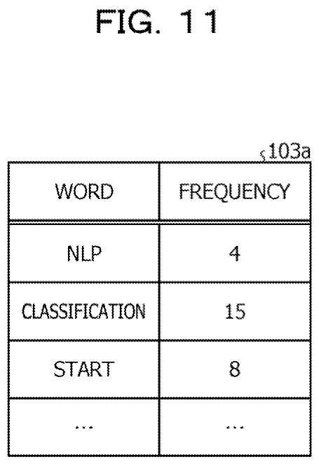

The dictionary information storage unit 103 is a storage device that stores the summary word dictionary and the original text dictionary. FIG. 11 is a diagram illustrating an example of a data structure of the summary word dictionary. As illustrated in FIG. 11, a summary word dictionary 103a associates a word with a frequency. The word in the summary word dictionary 103a is a word that is included only in the summary sentence as a result of comparing the pair of the input sentence and the summary sentence of the learning data 70. The frequency is an appearance frequency of a word that appears in a summary sentence.

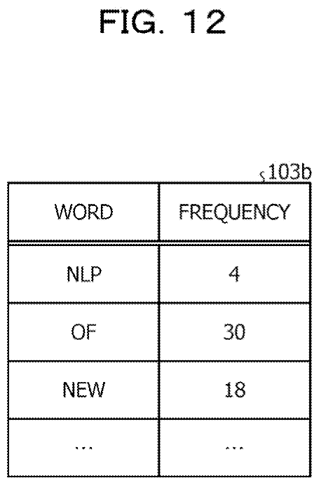

FIG. 12 is a diagram illustrating an example of a data structure of the original text dictionary. As illustrated in FIG. 12, an original text dictionary 103b associates a word with a frequency. The word in the original text dictionary 103b is a word included in each input sentence of the learning data 70. The frequency is an appearance frequency of a word that appears in an input sentence.

The description returns to FIG. 10. The model storage unit 104 is a storage device that stores a parameter of the encoder 50 and a parameter of the decoder 60. For example, the parameter of the encoder 50 includes the parameter θ₅₁ of the LSTM 51. The parameter of the decoder 60 includes the parameter θ₆₁ of the LSTM 61.

The encoder execution unit 105a is a processing unit that executes the encoder 50 described with reference to FIG. 9. For example, the encoder execution unit 105a develops the LSTM 51 or the like on a work area (memory or the like). The encoder execution unit 105a sets the parameter θ₅₁ of the LSTM 51 stored in the model storage unit 104 to the LSTM 51. In a case where the update unit 108 to be described later updates the parameter θ₅₁ of the LSTM 51, the encoder execution unit 105a sets the updated parameter θ₅₁ to the LSTM 51.

Here, the encoder execution unit 105a acquires an original text dictionary 103b stored in the dictionary information storage unit 103. In a case where each word (vector) of the input sentence of the learning data 70 is input to the encoder 50, the encoder execution unit 105a determines whether or not the input word exists in the original text dictionary 103b. In a case where the input word exists in the original text dictionary 103b, the encoder execution unit 105a inputs a vector of the word to the encoder 50.

On the other hand, in a case where the input word does not exist in the original text dictionary 103b, the encoder execution unit 105a inputs a vector “Unknown” to the encoder 50.

The decoder execution unit 105b is a processing unit that executes the decoder 60 described with reference to FIG. 9. For example, the decoder execution unit 105b develops the LSTM 61 or the like on a work area (memory or the like). The decoder execution unit 105b sets the parameter θ₆₁ of the LSTM 61 stored in the model storage unit 104 to the LSTM 61. In a case where the update unit 108 to be described later updates the parameter θ₆₁ of the LSTM 61, the decoder execution unit 105b sets the updated parameter θ₆₁ to the LSTM 61.

The decoder execution unit 105b acquires a summary sentence to be paired with the input sentence input to the encoder 50 by the encoder execution unit 105a from the learning data 70 and inputs the summary sentence to the decoder 60. A word input to the decoder 60 by the decoder execution unit 105b is set as “BOS”. The decoder execution unit 105b outputs information regarding correct words that are sequentially input to the decoder 60 to the loss calculation unit 107.

The calculation unit 106 is a processing unit that calculates various probability distributions on the basis of the output result of the encoder 50 executed by the encoder execution unit 105a and the output result of the decoder 60 executed by the decoder execution unit 105b.

The calculation unit 106 develops the summary word dictionary 103a on a work area (memory or the like). The calculation unit 106 calculates the probability distribution D2 of each word included in the summary word dictionary 103a on the basis of the hidden state vector output from the LSTM 61 and the summary word dictionary 103a. Furthermore, the calculation unit 106 calculates the probability distribution D1 of each word copied from the input sentence on the basis of the hidden state vector calculated when the input sentence is input to the encoder 50 and the hidden state vector output from the LSTM 61. The information processing device calculates the probability distribution D3 obtained by adding the probability distributions D1 and D2.

Note that, of the words copied from the input sentence, the word that is not included in the original text dictionary 103b is set as “Unknown” and is included in the probability distribution D1, and a probability is calculated. Furthermore, in a case where the words of the probability distribution D1 include “Unknown”, information indicating the number of the word from the beginning of the input sentence is given to the “Unknown”. Copying from the input sentence is performed using the information indicating the number of the word from the beginning.

For example, as described with reference to FIG. 9, the calculation unit 106 calculates the probability distribution D3 at each of the first to fourth times, and outputs the probability distribution D3 at each time to the loss calculation unit 107.

The loss calculation unit 107 is a processing unit that calculates a loss at each time by comparing the probability distribution D3 at each time acquired from the calculation unit 106 and the correct word acquired from the decoder execution unit 105b. The loss calculation unit 107 outputs information regarding the loss at each time to the update unit 108.

The update unit 108 is a processing unit that updates the parameter θ₅₁ of the LSTM 51 and the parameter θ₆₁ of the LSTM 61 so as to minimize the loss at each time acquired from the loss calculation unit 107. For example, the update unit 108 updates the parameters including the parameter θ₅₁ of the LSTM 51 and the parameter θ₆₁ of the LSTM 61 that are stored in the model storage unit 104 by optimizing a log likelihood on the basis of the losses at the first to fourth times.

As described with reference to FIGS. 3 to 8, the generation unit 100B is a processing unit that generates the summary sentence from the input sentence using the learned encoder 50 and the decoder 60. The generation unit 100B includes an acquisition unit 110, an encoder execution unit 111a, a decoder execution unit 111b, a calculation unit 112, and the generation unit 113.

The acquisition unit 110 is a processing unit that acquires an input sentence to be summarized via an input device or the like. The acquisition unit 110 outputs the acquired input sentence to the encoder execution unit 111a.

The encoder execution unit 111a is a processing unit that executes the encoder 50 described with reference to FIGS. 3 to 8. For example, the encoder execution unit 111a develops the LSTM 51 or the like on a work area (memory or the like). The encoder execution unit 111a sets the parameter θ₅₁ of the LSTM 51 stored in the model storage unit 104 to the LSTM 51.

The encoder execution unit 111a acquires the original text dictionary 104b stored in the dictionary information storage unit 103. In a case where each word (vector) of the input sentence received from the acquisition unit 110 is input to the encoder 50, the encoder execution unit 105a determines whether or not the input word exists in the original text dictionary 103b. In a case where the input word exists in the original text dictionary 103b, the encoder execution unit 111a inputs a vector of the word to the encoder 50.

On the other hand, in a case where the input word does not exist in the original text dictionary 103b, the encoder execution unit 111a inputs a vector “Unknown” to the encoder 50.

The decoder execution unit 111b is a processing unit that executes the decoder 60 described with reference to FIGS. 3 to 8. For example, the decoder execution unit 111b develops the LSTM 61 or the like on a work area (memory or the like). The decoder execution unit 111b sets the parameter θ₆₁ of the LSTM 61 stored in the model storage unit 104 to the LSTM 61.

The calculation unit 112 is a processing unit that calculates various probability distributions on the basis of an output result of the encoder 50 executed by the encoder execution unit 111a and an output result of the decoder 60 executed by the decoder execution unit 111b.

The calculation unit 112 develops the summary word dictionary 103a on a work area (memory or the like). The calculation unit 112 calculates the probability distribution D2 of each word included in the summary word dictionary 103a on the basis of the hidden state vector output from the LSTM 61 and the summary word dictionary 103a. Furthermore, the calculation unit 112 calculates the probability distribution D1 of each word copied from the input sentence on the basis of the hidden state vector calculated when the input sentence is input to the encoder 50 and the hidden state vector output from the LSTM 61. The information processing device calculates the probability distribution D3 obtained by adding the probability distributions D1 and D2.

The calculation unit 112 outputs the probability distribution D3 at each time to the generation unit 113.

The generation unit 113 is a processing unit that generates words in a summary sentence on the basis of the probability distribution D3 at each time output from the calculation unit 112. The generation unit 113 repeatedly executes the processing for generating a word corresponding to the maximum probability of the probabilities in the probability distribution D3 as the word in the summary sentence at each time. For example, in a case where a probability of “NLP” is the maximum among the probabilities of the respective words in the probability distribution D3 at an I-th time, “NLP” is generated as an l-th word from the beginning of the summary sentence.

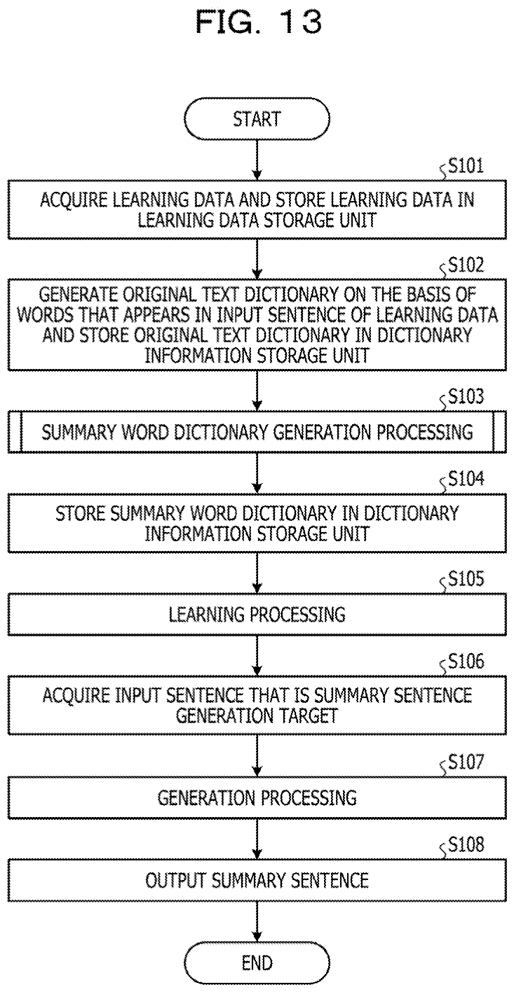

Next, an example of a processing procedure of the information processing device 100 according to the present embodiment will be described. FIG. 13 is a flowchart illustrating a processing procedure of the information processing device according to the present embodiment. As illustrated in FIG. 13, the learning unit 100A of the information processing device 100 acquires learning data and stores the learning data in the learning data storage unit 101 (step S101).

The dictionary generation unit 102 of the information processing device 100 generates an original text dictionary 103b on the basis of words that appear in an input sentence of the learning data and stores the original text dictionary 103b in the dictionary information storage unit 103 (step S102).

The dictionary generation unit 102 executes summary word dictionary generation processing (step S103). The dictionary generation unit 102 stores a summary word dictionary 103a in the dictionary information storage unit 103 (step S104).

The learning unit 100A executes learning processing (step S105). The acquisition unit 110 of the information processing device 100 acquires an input sentence that is a summary sentence generation target (step S106). The generation unit 100B executes generation processing (step S107). The generation unit 100B outputs the summary sentence (step S108).

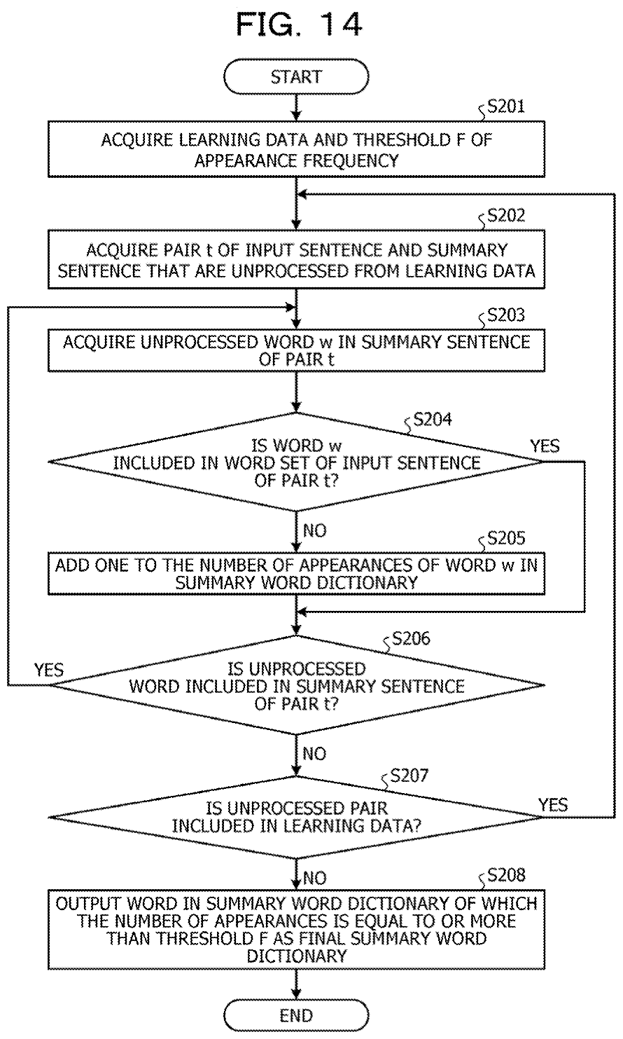

Next, an example of the summary word dictionary generation processing described in step S103 in FIG. 13 will be described. FIG. 14 is a flowchart illustrating a processing procedure of the summary word dictionary generation processing. As illustrated in FIG. 14, the dictionary generation unit 102 of the information processing device 100 acquires learning data and a threshold F of an appearance frequency from the learning data storage unit 101 (step S201).

The dictionary generation unit 102 acquires a pair t of an input sentence and a summary sentence that are unprocessed from the learning data (step S202). An unprocessed word w in the summary sentence of the pair t is acquired (step S203). In a case where the word w is included in a word set of the input sentence of the pair t (step S204, Yes), the dictionary generation unit 102 proceeds the procedure to step S206.

On the other hand, in a case where the word w is not included in the word set of the input sentence of the pair t (step S204, No), the dictionary generation unit 102 adds one to the number of appearances of the word w in the summary word dictionary (step S205).

In a case where an unprocessed word is included in the summary sentence of the pair t (step S206, Yes), the dictionary generation unit 102 proceeds the procedure to step S203. On the other hand, in a case where an unprocessed word is not included in the summary sentence of the pair t (step S206, No), the dictionary generation unit 102 proceeds the procedure to step S207.

In a case where the learning data includes an unprocessed pair (step S207, Yes), the dictionary generation unit 102 proceeds the procedure to step S202. On the other hand, in a case where the learning data does not include an unprocessed pair (step S207, No), the dictionary generation unit 102 proceeds the procedure to step S208.

The dictionary generation unit 102 outputs a word in the summary word dictionary of which the number of appearances is equal to or more than the threshold F as a final summary word dictionary (step S208).

Next, effects of the information processing device 100 according to the present embodiment will be described. In a case of generating the summary word dictionary 103a used by the Pointer-Generator, the information processing device 100 compares each pair of the input sentence and the summary sentence and registers the word that is included only in the summary sentence to the summary word dictionary 103a. As a result, it is possible to reduce a data amount of the summary word dictionary 103a, and it is possible to reduce a memory usage.

The information processing device 100 aggregates a frequency of a word, not included in the input sentence, in the summary sentence and registers a word of which a frequency is equal to or more than a predetermined frequency to the summary word dictionary 103a so as to further reduce the data amount of the summary word dictionary 103a.

The information processing device 100 specifies the words in the summary sentence on the basis of the probability distribution D3 obtained by adding the probability distribution D1 of each word copied from the input sentence and the probability distribution D2 of each word included in the summary word dictionary 103a. This makes it possible to generate the summary sentence using the words included in the summary word dictionary 103a or the words in the input sentence.

Next, an example of a hardware configuration of a computer that implements functions similar to those of the information processing device 100 described in the embodiment above will be described in order.

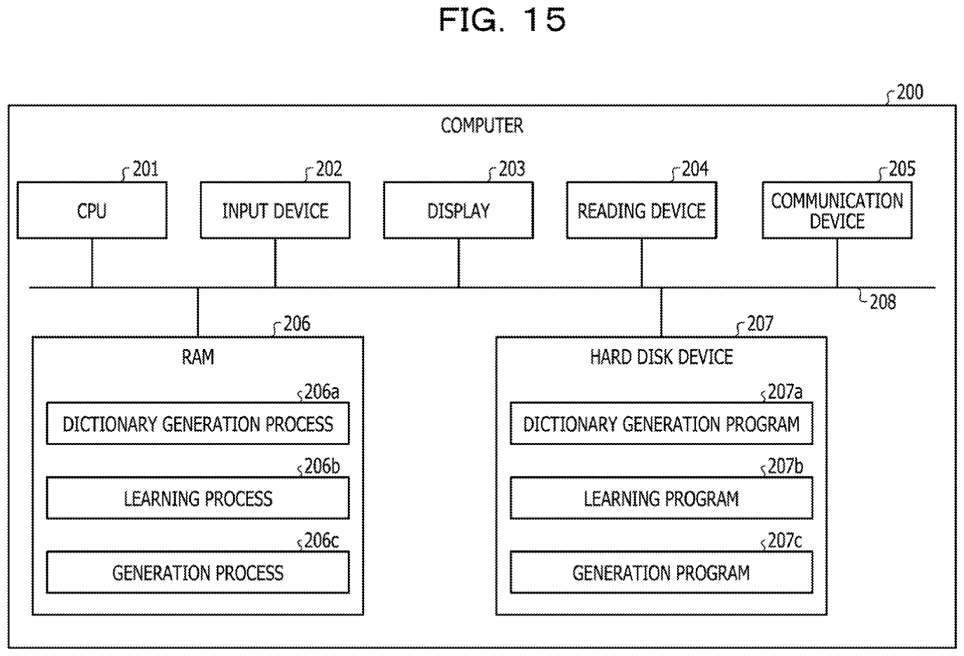

FIG. 15 is a diagram illustrating an example of a hardware configuration of a computer that implements functions similar to those of the information processing device. As illustrated in FIG. 15, a computer 200 includes a CPU 201 that executes various types of arithmetic processing, an input device 202 that receives an input of data from a user, a display 203, and a reading device 204. Furthermore, the computer 200 includes a communication device 205 that exchanges data with an external device via a network. The computer 200 includes a RAM 206 that temporarily stores various types of information, and a hard disk device 207. Then, each of the devices 201 to 207 is connected to a bus 208.

The hard disk device 207 includes a dictionary generation program 207a, a learning program 207b, and a generation program 207c. The CPU 201 reads the dictionary generation program 207a, the learning program 207b, and the generation program 207c and develops the programs on the RAM 206.

The dictionary generation program 207a functions as a dictionary generation process 206a. The learning program 207b functions as a learning process 206b. The generation program 207c functions as a generation process 206c.

Processing of the dictionary generation process 206a corresponds to the processing of the dictionary generation unit 102. Processing of the learning process 206b corresponds to the processing of the learning unit 100A (excluding dictionary generation unit 102). Processing of the generation process 206c corresponds to the processing of the generation unit 100B.

Note that each of the programs 207a to 207c does not need to be stored in the hard disk device 207 beforehand. For example, each of the programs is stored in a “portable physical medium” such as a flexible disk (FD), a compact disc read only memory (CD-ROM), a digital versatile disc (DVD) disk, a magneto-optical disk, or an integrated circuit (IC) card to be inserted in the computer 200. Then, the computer 200 may read and execute each of the programs 207a to 207c.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing method for a computer to execute a process comprising:
extracting, from a first document, a word that is not included in a second document;
registering the word in a first dictionary;
acquiring an intermediate representation vector by inputting a word included in the second document to a recursion-type encoder in order;
acquiring a first probability distribution based on a result of inputting the intermediate representation vector to a recursion-type decoder that calculates a probability distribution of each word registered in the first dictionary;
acquiring a second probability distribution of a second dictionary of a word included in the second document based on a hidden state vector calculated by inputting each word included in the second document to the recursion-type encoder and a hidden state vector output from the recursion-type decoder; and
generating word included in the first document based on the first probability distribution and the second probability distribution.

2. The information processing method according to claim 1, wherein the extracting includes:
acquiring a pair of an input sentence and a summary sentence obtained by summarizing the input sentence, and
extracting a word in the summary sentence that is not included in the input sentence.

3. The information processing method according to claim 2, wherein the registering includes:
aggregating a frequency of the word that is not included in the input sentence, in the summary sentence, and
registering a word whose frequency is equal to or more than a certain frequency in the first dictionary.

4. The information processing method according to claim 1, wherein the generating includes generating a word included in the first document based on a probability distribution obtained by adding the first probability distribution in which a first weight is multiplied and the second probability distribution in which a second weight smaller than the first weight is multiplied.

5. A non-transitory computer-readable storage medium storing an information processing program that causes at least one computer to execute a process, the process comprising:
extracting, from a first document, a word that is not included in a second document;
registering the word in a first dictionary;
acquiring an intermediate representation vector by inputting a word included in the second document to a recursion-type encoder in order;
acquiring a first probability distribution based on a result of inputting the intermediate representation vector to a recursion-type decoder that calculates a probability distribution of each word registered in the first dictionary;
acquiring a second probability distribution of a second dictionary of a word included in the second document based on a hidden state vector calculated by inputting each word included in the second document to the recursion-type encoder and a hidden state vector output from the recursion-type decoder; and
generating word included in the first document based on the first probability distribution and the second probability distribution.

6. The non-transitory computer-readable storage medium according to claim 5, wherein the extracting includes:
acquiring a pair of an input sentence and a summary sentence obtained by summarizing the input sentence, and
extracting a word in the summary sentence that is not included in the input sentence.

7. The non-transitory computer-readable storage medium according to claim 6, wherein the registering includes:
aggregating a frequency of the word that is not included in the input sentence, in the summary sentence, and
registering a word whose frequency is equal to or more than a certain frequency in the first dictionary.

8. The non-transitory computer-readable storage medium according to claim 5, wherein the generating includes generating a word included in the first document based on a probability distribution obtained by adding the first probability distribution in which a first weight is multiplied and the second probability distribution in which a second weight smaller than the first weight is multiplied.

9. An information processing device comprising:
one or more memories; and
one or more processors coupled to the one or more memories and the one or more processors configured to:
extract, from a first document, a word that is not included in a second document,
register the word in a first dictionary,
acquire an intermediate representation vector by inputting a word included in the second document to a recursion-type encoder in order,
acquire a first probability distribution based on a result of inputting the intermediate representation vector to a recursion-type decoder that calculates a probability distribution of each word registered in the first dictionary,
acquire a second probability distribution of a second dictionary of a word included in the second document based on a hidden state vector calculated by inputting each word included in the second document to the recursion-type encoder and a hidden state vector output from the recursion-type decoder, and
generate word included in the first document based on the first probability distribution and the second probability distribution.

10. The information processing device according to claim 9, wherein the one or more processors is further configured to:
acquire a pair of an input sentence and a summary sentence obtained by summarizing the input sentence, and
extract a word in the summary sentence that is not included in the input sentence.

11. The information processing device according to claim 10, wherein the one or more processors is further configured to:
aggregate a frequency of the word that is not included in the input sentence, in the summary sentence, and
register a word whose frequency is equal to or more than a certain frequency in the first dictionary.

12. The information processing device according to claim 9, wherein the one or more processors is further configured to
generate a word included in the first document based on a probability distribution obtained by adding the first probability distribution in which a first weight is multiplied and the second probability distribution in which a second weight smaller than the first weight is multiplied.
